(19) United States
(12) Patent Application Publication
(10) Pub. No.: US 2017/0087740 A1
(43) Pub. Date: Mar. 30, 2017

(54) ROTARY LOG DEBARKER WITH TILTING SYSTEM

(71) Applicant: LES ACIERS J.P. INC., La Reine (CA)

(72) Inventor: René Perreault, La Reine (CA)

(21) Appl. No.: 14/870,813

(22) Filed: Sep. 30, 2015

(51) Int. Cl. B27L 1/10

(52) U.S. Cl. CPC B27L 1/10

(57) ABSTRACT

A rotary log debarker comprising a container. The container comprises a bottom part, two opposed longitudinal walls extending upward from the bottom part, one end wall, and a chute. The bottom part comprises rotors being drivable by a power source. The rotors comprise a plurality of debarking plates. The debarking plates comprise an abrasive surface. The rotary log debarker is characterized in that it is provided with a tilting system for adjustable tilting of the container about a pivot point.

### FIELD

The present invention field generally relates to rotary log debarkers. More particularly, the invention relates to a rotary log debarker with a tilting system.

### BACKGROUND

Log debarkers are typically used in the wood and timber industry. They are designed to remove bark from wood logs, subsequently producing forest biomass. Log debarkers can use various mechanisms to remove bark from wood logs. Typical debarkers generally comprise ring debarkers, flail debarkers, cutter head debarkers, drum debarkers and rotary debarkers. Once bark is removed from the logs, the logs are ready to be used to produce wood products such as wood chips.

An objective of log debarking is to obtain a given degree of log cleanliness depending on the intended application of the debarked logs, while reducing wood losses on the logs. Reaching the desired degree of cleanliness is an important factor since it directly influences the quality and the value of the wood products produced from the debarked logs. A high degree of efficiency is desired to produce quality logs at a high rate.

Ring debarkers and cutter head debarkers generally offer the possibility to remove the bark from only one log at a time, which is not always ideal when high yields are required. The productivity is also reduced when small diameter logs are being debarked. On the other hand, drum debarkers and flail debarkers do allow for multiple logs to be loaded at the same time. However the cleanliness of the logs can be suboptimal and large diameters logs cannot generally be processed. Rotary debarkers are efficient only for certain species of wood.

Moreover, with the typical log debarkers, it is not always possible to ensure a constant productivity when the log parameters are changing, such as their diameter, their shape and even the species of the trees.

Considering the above, there is presently a need for an improved log debarker in order to overcome at least some of the mentioned drawbacks.

### SUMMARY

In some implementations, there is provided a rotary log debarker comprising a container. The container comprises a bottom part, two opposed longitudinal walls extending upward from the bottom part, one end wall, and a chute. The bottom part comprises rotors being drivable by a power source. The rotors comprise a plurality of debarking plates. The debarking plates comprise an abrasive surface. The rotary log debarker is characterized in that it is provided with a tilting system for adjustable tilting of the container about a pivot point.

In some implementations, the rotary log debarker further comprises a stabilizer to stabilize the container upon tilting the container.

In some implementations, the tilt angle of the container determines a longitudinal travel speed of the logs being debarked.

In some implementations, the debarking plates further comprise at least one abrader tool.

In some implementations, the at least one abrader tool comprise at least one tooth.

In some implementations, the rotary log debarker further comprises an output conveyor, to convey bark from the logs being debarked.

In some implementations, the rotary log debarker is mountable onto a vehicle.

In some implementations, there is provided a rotary log debarker comprising a container. The container comprises a bottom part, two opposed longitudinal walls extending upward from the bottom part, one end wall, and a chute. The bottom part comprises rotors being drivable by a power source. The rotors comprise a debarking plate base assembly comprising an abrasive surface and an debarking plate base assembly placeable above the rotors. The debarking plate base assembly comprises transversal openings shaped and positioned such that the debarking plate base assembly interlaces with the debarking plates. The rotary log debarker is characterized in that it is provided with a tilting system for adjustable tilting of the container about a pivot point.

In some implementations, the rotary log debarker comprises a stabilizer to stabilize the container upon tilting the container.

In some implementations, the tilt angle of the container determines a longitudinal travel speed of the logs being debarked.

In some implementations, the debarking plate base assembly further comprise serrated plates.

In some implementations, the debarking plates further comprise at least one abrader tool.

In some implementations, the at least one abrader tool comprise at least one tooth.

In some implementations, the rotary log debarker comprises an output conveyor, to convey bark from the logs being debarked.

In some implementations, the rotary log debarker is mountable onto a vehicle.

In some implementations, the at least one of the longitudinal wall has at least a rotatable panel attached thereto.

In some implementations, the end wall has at least a rotatable panel attached thereto.

In some implementations, each rotatable panel is manually driven.

In some implementations, each rotatable panel is hydraulically driven.

In some implementations, there is provided a process for debarking logs using a rotary log debarker. The process comprises top-loading the logs in a container. The container comprises a bottom part, two opposed longitudinal walls extending upward from the bottom part, one end wall, and a chute. The bottom part comprises rotors. The rotors comprise a plurality of debarking plates with an abrasive surface, and are drivable by a power source. The bottom part further comprises a debarking plate base assembly placed above the rotors. The debarking plate base assembly comprises transversal openings shaped and positioned such that the debarking plate base assembly interlaces with the debarking plate. The process further comprises tilting the container in relation to a ground surface.

In some implementations, the process further comprises a step for stabilizing the container with a stabilizer upon tilting of the container.

In some implementations, the process further comprises a step a step for retrieving the debarked logs exiting the chute.

In some implementations, the process further comprises a step a step for conveying bark and debris from the logs being debarked, with an output conveyor located opposite to the end wall.

### BRIEF DESCRIPTION OF THE DRAWINGS

FIG. 1 is a top plan view of a rotary log debarker.

FIG. 2 is a side view of a rotary log debarker.

FIG. 3 is another side view of a rotary log debarker, showing a conveyor in a folded position.

FIG. 4 is a perspective view of a rotary log debarker illustrating debarking plate base assembly above rotors, rotable panels on a longitudinal wall and rotatable panels on an end wall.

FIG. 5 is an exploded perspective view of a rotary log debarker.

FIG. 6 is an exploded perspective view of a rotary log debarker, showing a localization of rotors and debarking plate base assembly having rotatable panels on a longitudinal wall and rotatable panels on an end wall.

FIG. 7 is a side view of rotors with debarking plates showing abrader tools and debarking plate base assembly with serrated plates.

FIG. 8 is a side view of a rotor illustrating debarking plates and abrader tools.

FIG. 9 is a perspective view of debarking plate base assembly illustrating serrated plates.

### DETAILED DESCRIPTION

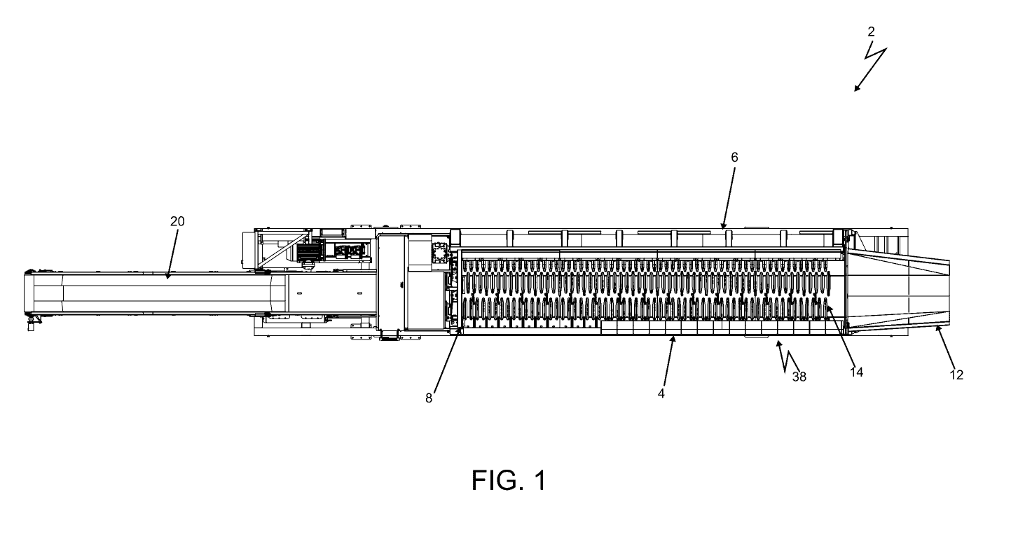

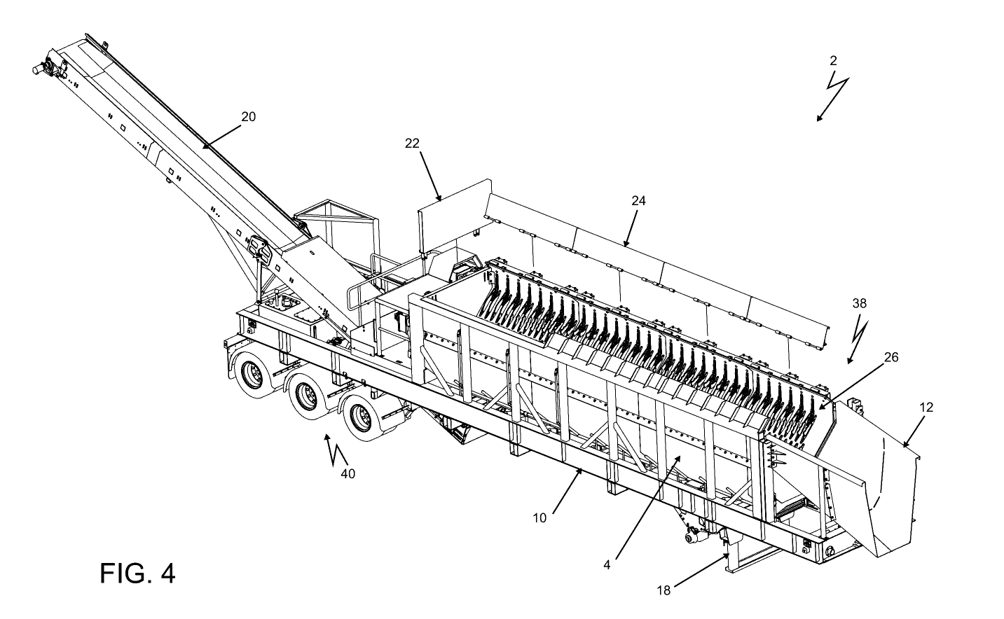

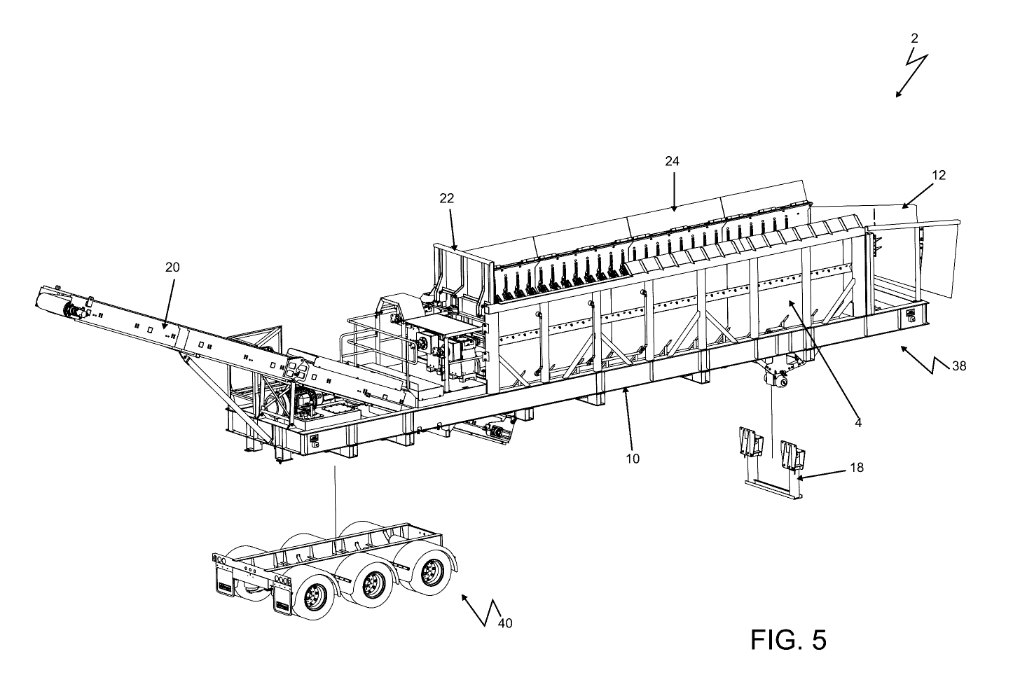

Referring to FIGS. 1 to 6, a rotary log debarker 2 in accordance with a preferred embodiment of the present invention is shown. The rotary log debarker 2 comprises a container 38 having a bottom part 10, two opposed longitudinal walls 4, 6, an end wall 8 and a chute 12. The bottom part 10 comprises a plurality of rotors 28. The rotors comprise a plurality of debarking plates 36 to remove the bark from the logs. The rotors 14 are powered by a power source 28. The container 38 comprises a tilting system 16 for adjustable tilting of the container 38 about a pivot point, in relation to a ground surface. In a preferred embodiment, a stabilizer can be used to stabilize the container 38 upon being titled. Tilting the container 38 can allow for the adjustment of the travel speed of the logs being debarked and can also facilitate a better control of the debarking conditions.

Having the possibility to adjust the travel speed of the logs and being able to control of the debarking conditions depending of the parameters of the logs to be debarked can result in an increased efficiency and productivity. In one embodiment, the stabilizer can be a retractable leg 18. The retractable leg 18 can have an adjustable height, which provides the leg with the opportunity to adopt the required height to provide the support to the container 38 depending on the tilt angle of the container 38.

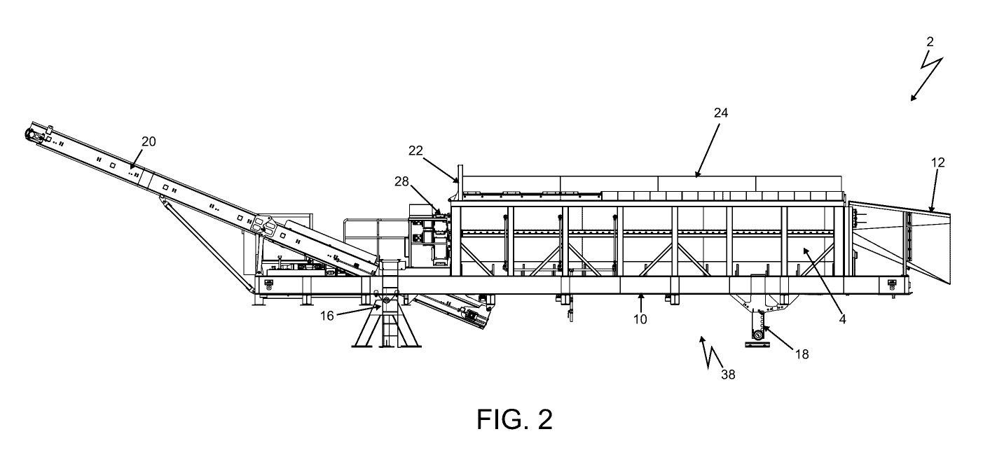

In a preferred embodiment, the tilting system 16 and the stabilizer 18 are arranged horizontally, in an opposed relationship, as shown in FIG. 2. In another preferred embodiment, the tilting system 16 can consist of a three leg support of adjustable height, being rotatably connected to the container 38 and being able to pivot the container 38. In another preferred embodiment, the rotary log debarker 2 is mountable onto a vehicle, optionally using a three axel trailer 40. Such assembly allows for the rotary log debarker 2 to be easily transported.

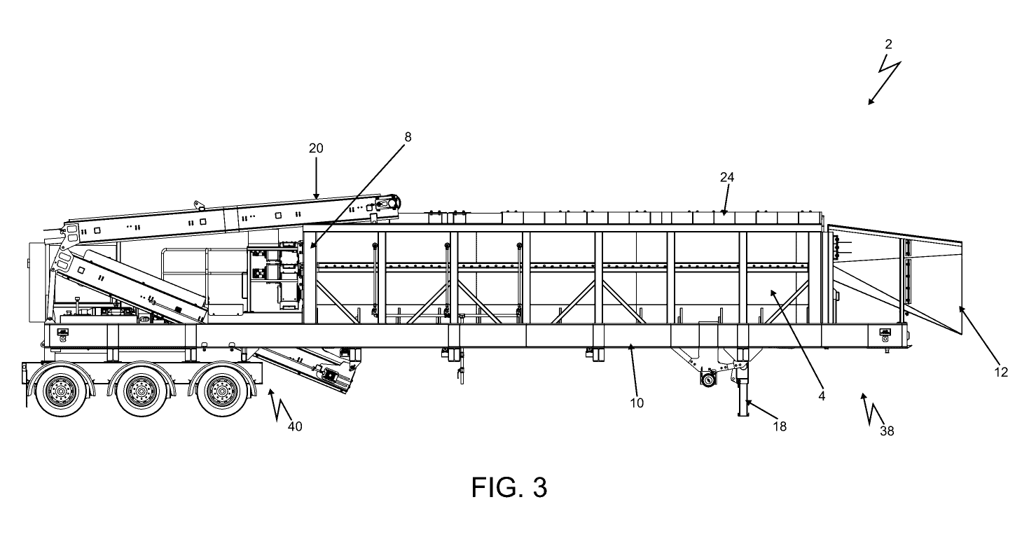

Still referring to FIGS. 1 to 6, debarked logs can exit the container 38 using the chute 12. Bark from the debarked logs can be conveyed with an output conveyor 20. Preferably, the output conveyor 20 is located opposite to the chute 12. FIG. 2 shows the output conveyor 20 in an open configuration, and FIG. 3 shows the output conveyor 20 in a closed configuration, the closed configuration being used optionally during transportation of the rotary log debarker 2.

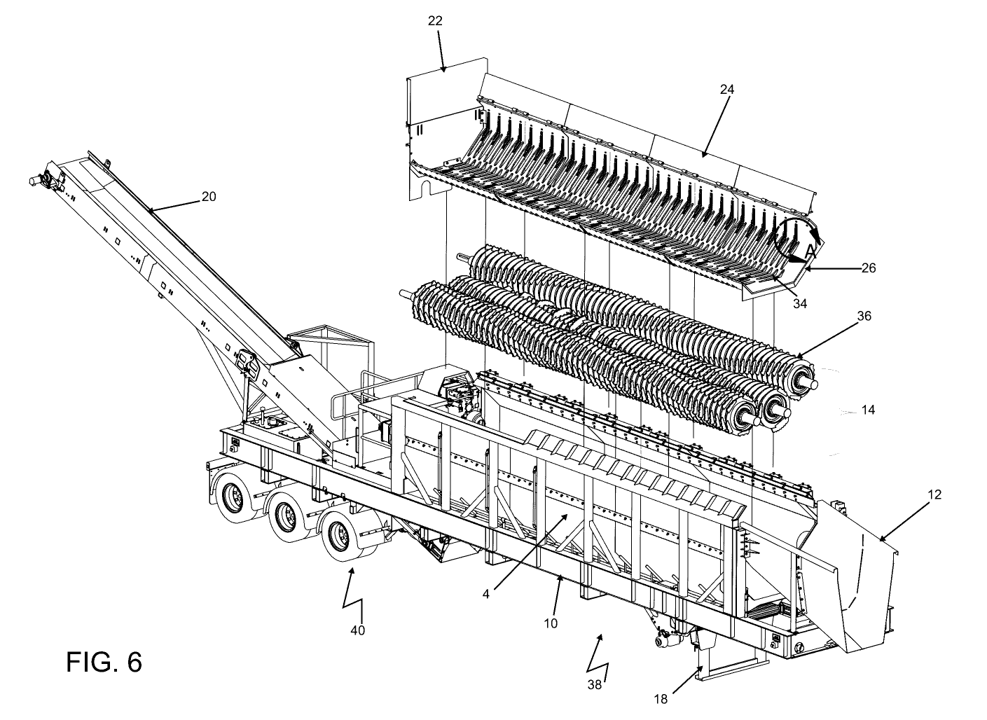

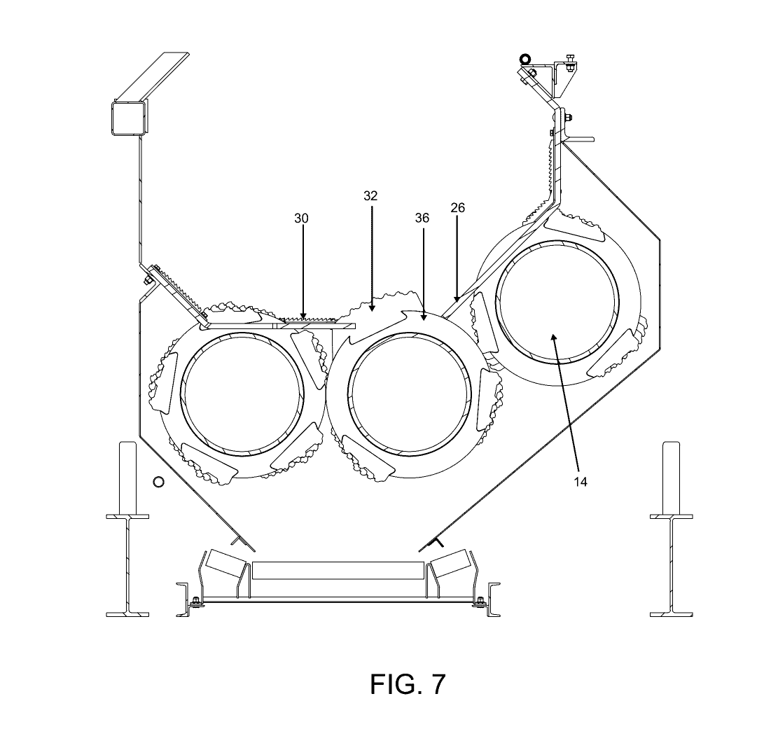

Referring to FIGS. 6 and 7, the rotary log debarker 2 can include a debarking plate base assembly 26 located above the rotors 14. Angle configuration of the debarking plate base assembly 26 can be determined according to the placement of the rotors at the bottom of the container or other criteria such as the debarking requirements. The debarking plate base assembly 26 has transversal opening sections 34 allowing for interlacing between the debarking plates 36 and the debarking plate base assembly 26. The debarking plates 36 are thus exposed to the logs, while minimizing wedging of logs between the debarking plates 36 and sidewalls of the debarker or even wedging of logs between adjacent debarking plates 36.

Still referring to FIGS. 6 and 7, the debarking plate base assembly 26 can include a rotatable panel or a series of rotatable panels 24 located on a long side of the debarking plate base assembly 26, and a rotatable panel or a series of rotatable panels 22 located on a short side of the debarking plate base assembly 26. Alternatively, the rotatable panels can be attached the longitudinal wall 4, 6 or the end wall 8 of the container 38. The rotatable panels 22, 24 can be driven manually or hydraulically. The rotatable panels 22, 24 are located such that they prevent the logs being debarked to be ejected from the container 38 while the debarker 2 is in function.

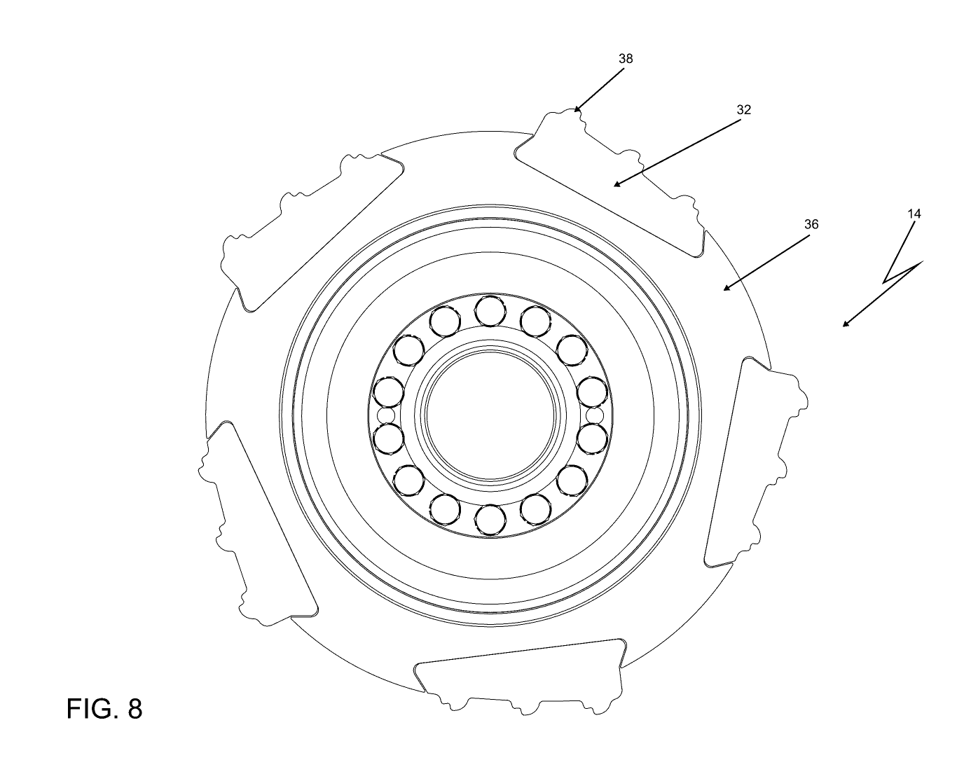

Referring to FIGS. 7 to 9, the rotors 14 comprise debarking plates 36. The debarking plates 36 can comprise abrader tools 32, which in turn can comprise at least one tooth 38. Various configurations of the debarking plates 36 and the abrader tools 32 can be chosen according to the characteristics of the logs to be debarked or other considerations.

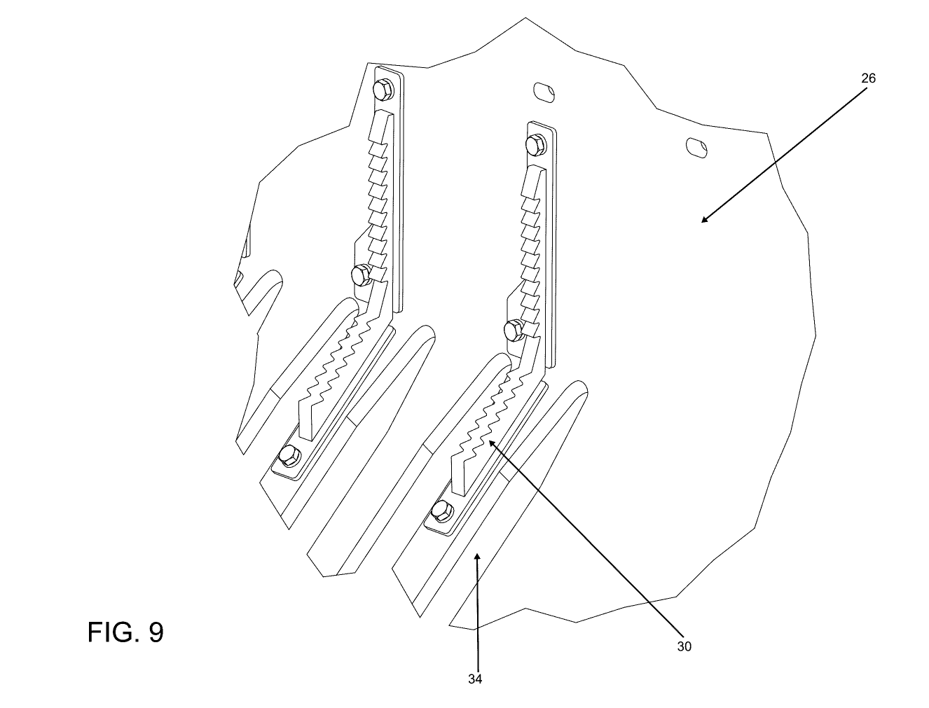

Referring to FIG. 9, the debarking plate base assembly can comprise serrated plates 30 located for example in between the transversal opening sections 34. The serrated plates 30 can allow for an increased debarking efficacy and efficiency. Various serration patterns can be chosen according to the debarking needs.

In the above description, the same numerical references refer to similar elements. Furthermore, for the sake of simplicity and clarity, namely so as to not unduly burden the figures with several reference numbers, not all figures contain references to all the components and features, and references to some components and features may be found in only one figure, and components and features of the present invention illustrated in other figures can be easily inferred therefrom. The embodiments, geometrical configurations, materials mentioned and/or dimensions shown in the figures are optional, and are given for exemplification purposes only.

Furthermore, although the present invention may be used with various objects, such as debarkers, for example, it is understood that it may be used with other debarking systems. For this reason, expressions such as “debarker”, “debarking plate”, etc. not be taken as to limit the scope of the present invention to these devices. These expressions encompass all other kinds of materials, objects and/or purposes with which the present invention could be used and may be useful, as can be easily understood.

1. A rotary log debarker comprising:
a container, the container comprising:
a bottom part, two opposed longitudinal walls extending upward from the bottom part, one end wall, and a chute, the bottom part comprising:
rotors being drivable by a power source, wherein the rotors further comprise a plurality of debarking plates comprising an abrasive surface;
a tilting system for adjustable tilting of the container about a pivot point.

2. A rotary log debarker according to claim 1, further comprising a stabilizer to stabilize the container upon tilting the container.

3. A rotary log debarker according to claim 1, wherein a tilt angle of the container determines a longitudinal travel speed of the logs being debarked.

4. A rotary log debarker according to claim 1, wherein the debarking plates further comprise at least one abrader tool.

5. A rotary log debarker according to claim 4, wherein the at least one abrader tool comprise at least one tooth.

6. A rotary log debarker according to claim 1, further comprising an output conveyor, to convey bark from the logs being debarked.

7. A rotary log debarker according to claim 1, wherein the rotary log debarker is mountable onto a vehicle.

8. A rotary log debarker comprising:
a container, the container comprising:
a bottom part, two opposed longitudinal walls extending upward from the bottom part, one end wall, and a chute, the bottom part comprising:
rotors being drivable by a power source, wherein the rotors further comprise a plurality of debarking plates comprising an abrasive surface; and
a debarking plate base assembly placeable above the rotors, the debarking plate base assembly comprising:
transversal openings shaped and positioned such that the debarking plate base assembly interlaces with the debarking plates;
a tilting system for adjustable tilting of the container about a pivot point.

9. A rotary log debarker according to claim 8, further comprising a stabilizer to stabilize the container upon tilting the container.

10. A rotary log debarker according to claim 8, wherein a tilt angle of the container determines a longitudinal travel speed of the logs being debarked.

11. A rotary log debarker according to claim 8, wherein the debarking plate base assembly further comprise serrated plates.

12. A rotary log debarker according to claim 8, wherein the debarking plates further comprise at least one abrader tool.

13. A rotary log debarker according to claim 12, wherein the at least one abrader tool comprise at least one tooth.

14. A rotary log debarker according to claim 8, further comprising an output conveyor, to convey bark from the logs being debarked.

15. A rotary log debarker according to claim 8, wherein the rotary log debarker is mountable onto a vehicle.

16. A rotary log debarker according to claim 8, wherein a long side of the debarking plate base assembly comprises at least a top rotatable panel attached thereto.

17. A rotary log debarker according to claim 8, wherein a short side of the debarking plate base assembly comprises at least a top rotatable panel attached thereto.

18. A rotary log debarker according to claim 16, wherein each rotatable panel is manually driven.

19. A rotary log debarker according to claim 16, wherein each rotatable panel is hydraulically driven.

20. A process for debarking logs using a rotary log debarker, the process comprising:
top-loading the logs in a container, the container comprising a bottom part, two opposed longitudinal walls extending upward from the bottom part, one end wall, and a chute, the bottom part comprising rotors, wherein the rotors further comprise a plurality of debarking plates with an abrasive surface, and being drivable by a power source; the bottom part further comprising a debarking plate base assembly placed above the rotors and the debarking plate base assembly comprising transversal openings shaped and positioned such that the debarking plate base assembly interlaces with the debarking plates; and
tilting the container in relation to a ground surface.

21. The process of claim 20, further comprising a step for stabilizing the container with a stabilizer upon tilting of the container.

22. The process of claim 20, further comprising a step for retrieving the debarked logs exiting the chute.

23. The process of claim 20, further comprising a step for conveying bark and debris from the logs being debarked, with an output conveyor located opposite to the end wall.
